(19) United States
(12) Patent Application Publication
(10) Pub. No.: US 2012/0245952 A1
(43) Pub. Date: Sep. 27, 2012

(54) CROWDSOURCING MEDICAL EXPERTISE

(75) Inventors: Marc W. HALTERMAN, Penfield, NY (US); Jeffrey P. Bigham, Rochester, NY (US); Henry Kautz, Rochester, NY (US); James W. Hill, Mission Viejo, CA (US)

(73) Assignee: University of Rochester, Rochester, NY (US)

(21) Appl. No.: 13/429,298

(22) Filed: Mar. 23, 2012

Related U.S. Application Data
(60) Provisional application No. 61/466,906, filed on Mar. 23, 2011.

(51) Int. Cl. G06Q 50/22

(52) U.S. Cl. 705/2

(57) ABSTRACT

Methods of crowdsourcing medical expert information are described. One such method includes receiving, from a first user during a first session over a network, a first query that includes a request for information regarding a patient condition, a therapy, and/or a medical test, and transmitting the query to a plurality of medical personnel. The first query further includes first session parameters selected by the first user from categories displayed by a processor to the first user. The method also includes receiving responses to the query from the plurality of medical personnel, and changing, based on the responses, an assigned probability of presenting to an index user, in response to a second query and during another session, at least one of a suggested diagnosis, a suggested therapy, a suggested inquiry to aid in establishing a diagnosis, a suggested medical test, a recommended source for further information, or a recommended medical professional.

### CROSS-REFERENCE TO RELATED APPLICATIONS

The present application claims the benefit of priority under 35 U.S.C. §119 from U.S. Provisional Patent Application Ser. No. 61/466,906 entitled “Crowdsourcing Medical Expertise,” filed on Mar. 23, 2011, the disclosure of which is hereby incorporated by reference in its entirety for all purposes.

### BACKGROUND

1. Field

The present disclosure generally relates to communications systems, and more particularly, to systems that assist with patient care.

2. Description of Related Art

The volume of existing knowledge and the pace of discovery in clinical sciences have made it difficult for physicians to consider all medical literature at the point of clinical care. Generalists, for example, who work at the front in clinical settings, are particularly challenged to maintain the breadth of clinical guidelines in their working memory. In practice, physicians learn to diagnose and treat that which they encounter frequently, but often lack the time required to retrieve up-to-date information on uncommon disorders dispersed in primary medical literature. The resulting costs include extra visits to medical specialists, unnecessary or redundant diagnostic medical tests, and increased time to a correct medical diagnosis. These factors increase the economic cost of healthcare services and decrease the quality of service to patients.

### SUMMARY

The disclosed systems, methods, and computer-readable media in certain embodiments allow a healthcare professional to crowdsource queries to a group of designated medical personnel for assistance with a patient case. The information received by the healthcare professional from the medical personnel is processed by the system for use in making future recommendations (e.g., diagnoses) in similar situations.

In certain embodiments, a method of crowdsourcing medical expert information is disclosed. The method includes receiving, from a first user during a first session over a network, a first query includes a request for information regarding at least one of a patient condition, a therapy, or a medical test, and transmitting the first query over the network to a plurality of medical personnel. The first query further includes first session parameters selected by the first user from categories displayed by a processor to the first user, the categories includes at least two of: therapies, diseases, organ systems, symptoms, clinical signs, medical tests, medical imaging, or genetic information. The method also includes receiving responses over the network to the first query from at least two of the plurality of medical personnel, the responses includes at least one of suggested diagnosis, a suggested therapy, a suggested inquiry to aid in establishing a diagnosis, a suggested medical test, a recommended source for further information, or a recommended medical professional. The method further includes transmitting to the first user an indicator of the responses, and based on the responses, changing an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

In certain embodiments of the method, the method further includes transmitting to the index user an indicator of the responses. The indicator of the responses is at least partially based on the changed assigned probability. The first user is the index user. At least some of the first session parameters are organized using electronic data tags. The assigned probability is changed based on a weighting of variables, wherein each of at least some of the variables represents a degree of similarity or of difference between the first and second queries. The weighting of variables includes providing a weight to at least one of the medical personnel, suggested diagnosis, suggested therapy, suggested inquiry to aid in establishing a diagnosis, suggested medical test, recommended source for further information, or recommended medical professional. The weighting of variables includes assigning a heavier weight to a diagnosis that has a greater potential for morbid consequences than a diagnosis that has a lesser potential for morbid consequences. The weighting of variables includes assigning a different weight to a response received from at least one of the plurality of personnel than from at least another of the plurality of personnel. The different weight is based at least in part on a reputation of the least one of the personnel, the reputation being based on at least a prior answer provided by the least one of the personnel to a prior query received from a user. The at least two of the plurality of medical personnel receive incentives for providing the responses. The method further includes providing to at least one of the plurality of medical personnel a different level of access to information regarding the first query than to another of the medical personnel. The method further includes compiling statistics associated with the at least one of suggested diagnosis, suggested therapy, suggested inquiry to aid in establishing a diagnosis, suggested medical test, recommended source for further information, or recommended medical professional based on the responses, and displaying the statistics to at least one of the first and index users. The query is selected by the first user from a group of queries displayed to the first user. The method further includes transmitting information, based on the responses, to at least some of the medical personnel. The method further includes transmitting a follow-up query to the at least two of the plurality of medical personnel for additional information based on the received responses. The presenting to the index user during another session includes presenting, based on the responses, at least one of a differential list of suggested diagnoses, a suggested therapy, a suggested inquiry to aid in establishing a diagnosis, a suggested medical test, a recommended source for further information, or a recommended medical professional.

In certain embodiments, a system of crowdsourcing medical expert information is disclosed. The system includes a memory storing instructions and a processor. The processor is configured to execute the instructions to receive, from a first user during a first session over a network, a query includes a request for information regarding at least one of a patient condition, a therapy, or a medical test, and transmit the query over the network to a plurality of medical personnel. The query further includes first session parameters selected by the first user from categories displayed by a processor to the first user, the categories includes at least two of: therapies, diseases, organ systems, symptoms, clinical signs, medical tests, medical imaging, or genetic information. The processor is further configured to execute the instructions to receive responses over the network to the first query from at least two of the plurality of medical personnel, the responses includes at least one of suggested diagnosis, a suggested therapy, a suggested inquiry to aid in establishing a diagnosis, a suggested medical test, a recommended source for further information, or a recommended medical professional, transmit to the first user an indicator of the responses, and based on the responses, change an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

In certain embodiments of the system, the processor is further configured to execute the instructions to transmit to the index user an indicator of the responses. The indicator of the responses is at least partially based on the changed assigned probability. The first user is the index user. At least some of the first session parameters are organized using electronic data tags. The assigned probability is changed based on a weighting of variables, wherein each of at least some of the variables represents a degree of similarity or of difference between the first and second queries. The weighting of variables includes providing a weight to at least one of the medical personnel, suggested diagnosis, suggested therapy, suggested inquiry to aid in establishing a diagnosis, suggested medical test, recommended source for further information, or recommended medical professional. The weighting of variables includes assigning a heavier weight to a diagnosis that has a greater potential for morbid consequences than a diagnosis that has a lesser potential for morbid consequences. The weighting of variables includes assigning a different weight to a response received from at least one of the plurality of personnel than from at least another of the plurality of personnel. The different weight is based at least in part on a reputation of the least one of the personnel, the reputation being based on at least a prior answer provided by the least one of the personnel to a prior query received from a user. The at least two of the plurality of medical personnel receive incentives for providing the responses. The processor is configured to execute the instructions to provide to at least one of the plurality of medical personnel a different level of access to information regarding the query than to another of the plurality of medical personnel. The processor is further configured to execute the instructions to compile statistics associated with the at least one of suggested diagnosis, suggested therapy, suggested inquiry to aid in establishing a diagnosis, suggested medical test, recommended source for further information, or recommended medical professional based on the responses, and display the statistics to at least one of the first and index users. The query is selected by the first user from a group of queries displayed to the first user. The processor is further configured to execute the instructions to transmit information, based on the responses, to at least some of the medical personnel. The processor is further configured to execute the instructions to transmit a follow-up query to the at least two of the plurality of medical personnel for additional information based on the received responses. The instructions to present to the index user during another session includes instructions to present, based on the responses, at least one of a differential list of suggested diagnoses, a suggested therapy, a suggested inquiry to aid in establishing the diagnosis, a suggested medical test, a recommended source for further information, or a recommended medical professional. The plurality of medical personnel is authorized to provide responses based on user credentials. The first query and the responses are received from at least one of a desktop computer, a mobile device, or an online user interface. The first query is received at a server from a mobile device and the responses are received at the server.

In certain embodiments, a machine-readable storage medium includes machine-readable instructions for causing a processor to execute a method of crowdsourcing medical expert information is disclosed. The method includes receiving, from a first user during a first session over a network, a first query includes a request for information regarding at least one of a patient condition, a therapy, or a medical test, and transmitting the first query over the network to a plurality of medical personnel. The first query further includes first session parameters selected by the first user from categories displayed by a processor to the first user, the categories includes at least two of: therapies, diseases, organ systems, symptoms, clinical signs, medical tests, medical imaging, or genetic information. The method also includes receiving responses over the network to the first query from at least two of the plurality of medical personnel, the responses includes at least one of suggested diagnosis, a suggested therapy, a suggested inquiry to aid in establishing a diagnosis, a suggested medical test, a recommended source for further information, or a recommended medical professional. The method further includes transmitting to the first user an indicator of the responses, and based on the responses, changing an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

In certain embodiments, a method of crowdsourcing medical expert information is disclosed. The method includes receiving, from a first user during a first session over a network, a first query comprising a request for information regarding at least one of a patient condition, a therapy, or a medical test, or transmitting the first query over the network to a plurality of medical personnel. The first query further comprises first session parameters selected by at least one of the first user and at least one of the plurality of medical personnel from user categories displayed by a processor, the categories comprising at least two of: therapies, diseases, organ systems, symptoms, clinical signs, medical tests, medical imaging, or genetic information. The method also includes receiving responses over the network to the first query from at least two of the plurality of medical personnel, the responses comprising at least one of suggested diagnosis, a suggested therapy, a suggested inquiry to aid in establishing a diagnosis, a suggested medical test, a recommended source for further information, or a recommended medical professional. The method further includes transmitting to the first user an indicator of the responses, and based on the responses, changing an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional. In certain embodiments of the method, the first session parameters are associated, by the first user or the at least two of the plurality of medical personnel, with categories including at least two of: therapies, diseases, organ systems, symptoms, clinical signs, medical tests, medical imaging, or genetic information.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary architecture for crowdsourcing medical expert information.

FIG. 2 is a block diagram illustrating an exemplary server in the architecture of FIG. 1 according to certain aspects of the disclosure.

FIG. 3A illustrates an exemplary process for providing information associated with a query.

FIG. 3B illustrates an exemplary process for crowdsourcing medical expert information using the exemplary server of FIG. 2.

FIG. 3C illustrates an exemplary workflow for a central disease information database in accordance with certain aspects of the disclosure.

FIG. 3D illustrates an exemplary workflow for a crowdsourced health information retrieval protocol in accordance with certain aspects of the disclosure.

FIGS. 4A and 4B are exemplary screenshots of user interfaces from the user client of FIG. 1.

FIG. 5 is a block diagram illustrating an exemplary computer system with which the user client, medical personnel devices, and server of FIG. 1 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Described herein are systems, methods, and software for crowdsourcing medical expert information. For example, a doctor attempting to diagnose or treat a patient can use his smartphone to contact a number of other doctors (e.g. the “crowd”) on their smartphones, laptops, or desktops with information on the patient in order to obtain feedback from those other doctors on how to diagnose, treat, and/or evaluate the patient. Similar future patient cases can leverage the feedback to present a doctor with information based on the feedback without requiring the doctor to contact other doctors.

Although the embodiments of the disclosed system are described with respect to medical expert information, the disclosed system can be used to crowdsource other information. For example, information can be crowdsourced that relates to the law, auto mechanics, aeromechanics, dentistry, veterinary medicine, history, geology, economics, engineering (e.g., mechanical, electrical), marketing, academics, political strategy, carpentry, interior design, architecture, and any other field that might benefit from obtaining expert information from multiple sources.

Certain embodiments of the disclosed system herein include a diagnostic algorithm for disease assessment that is used includes a disease database and a decision support system. The disclosed system is configured to provide statistically based recommendations regarding likely diagnoses, rational, and actionable testing strategies based on user specified input, and suggestions regarding additional questions and bedside examination techniques that can improve the accuracy of a clinical encounter. The disclosed system also includes a crowdsourced health information retrieval protocol (“CHIRP”) that provides an infrastructure for allowing users to broadcast focused clinical queries to prescribed colleagues participating in select expert networks. The disclosed system can be used with any field of medicine.

The disclosed system can be used, for example, as a reference tool by medical providers to help triage patients and identify the cause for their symptoms and signs and determine an efficient, cost effective plan for testing. The disclosed system can also be used as a teaching tool in the instruction of medical students, residents and fellows, and as a new form of communication enabling medical providers to create and share new information with one another regardless of geographic constraints. The disclosed system can further be used as a data server capable of creating new knowledge regarding disease characteristics and effective treatments, as a research tool to improve our understanding of how best to improve human-computer interactions in a clinical setting, and as a test preparation resource capable of using real-world clinical scenarios to generate examination style questions that deal with contemporary controversies in medical diagnosis, testing, and treatment.

With the disclosed system, users can interact either with information stored on a server or access specialized knowledge held by their trusted colleagues. This can be done using a web browser (e.g., on a desktop computer or laptop computer) or using a dedicated smart phone application. This facilitates a user gaining access to the information regardless of geography. The use of human-backed intelligence to support a database structure (e.g., on the server) that can be filtered by user-defined expert profiling and robust methods in artificial intelligence generates user trust in the system. Thus, if an answer to a query is not readily available on the server, a user will be able to call on his/her colleagues listed in the user's “keychain” of content experts. For example, if a user is unable to find sufficient information on the diagnosis “dementia” in the database of the system, the user can obtain additional information on dementia from medical personnel using the crowdsourcing aspect of the system. The additional information can then be incorporated in the database for future sessions/users. The output of the database can be formatted according to the preferences of users.

Furthermore, with the disclosed system, users can, for example, access templates that use codified diagnostic criteria and integrate information including symptoms, signs, and laboratory and imaging data to generate differential lists. A user can construct a preliminary diagnosis list incorporating a probability-based scoring system using both positive and negative patient-specific data that is weighted by the user according to the user's appraised value of the individual elements. In certain embodiments, an additional weighting strategy is provided that lists “do not miss” diagnoses according to their potential for morbid consequences. Limited demographic information (age, gender) may be factored into this algorithm, but, in certain embodiments, protected health information (PHI) may not be requested or accepted in order to protect patient confidentiality. A database may be established as a shell and populated with information provided by medical students and residents during a course of study. For example, the database can support a glossary of terms (exam findings, jargon) to enhance efficient information storage and retrieval, for example, to support a flash card style presentation of data from the database, to provide templates that concisely list disease facts for test review, to use filters and statistical approaches to appraise contributed information, and to provide links to online information sources (e.g., OMIM, PubMed references, Wikipedia disease pages).

Those users of the system seeking to use the information provided as an educational resource may create and share their data and integrate the work of others to enrich the knowledge base. Advanced functions may include modules linked with differential diagnoses that recommend focused, cost effective and efficient testing. User contributions may be cumulative, and incentives to participate will include a glossary of terms as well as masks provided to display disease related information in ways that enhance learning. Modules will be provided that support testing recommendations, provide additional historical questions and physical exam tests based on the provider's selections, and increase the yield of the clinical encounter. Providers may be surveyed to determine whether these functions enhance their clinical performance.

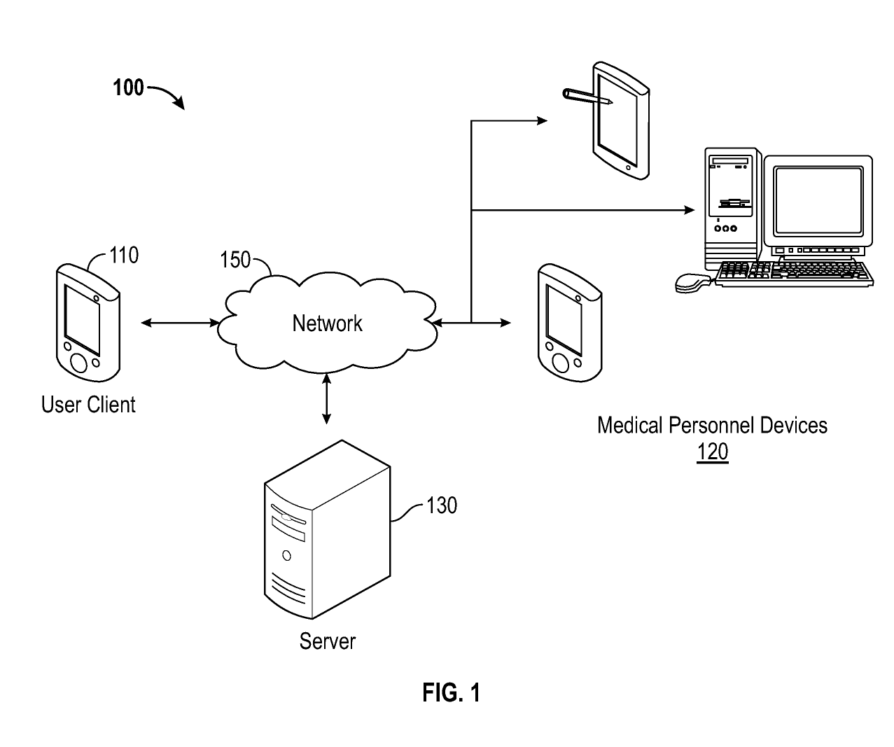

FIG. 1 illustrates an exemplary architecture 100 for crowdsourcing medical expert information. The architecture includes a user client 110, medical personnel devices 120, and a server 130 connected over a network 150.

The user client 110 is configured to receive, from a user during a first session, a query comprising a request for information regarding at least one of a patient condition, a therapy, and a medical test. The query is transmitted to the server 130 over the network. The server 130 then transmits the query over the network 150 to the medical personnel devices 120, each of the medical personnel devices 120 associated with a medical professional. At least two medical professionals provide a response to the query using their respective medical personnel devices 120. The responses are transmitted over the network 150 to the server 130. Based on the responses, the server 130 changes an assigned probability of presenting to an indexed user, during another session having parameters that share a degree of identity with the first session parameters, at least one of a suggested diagnosis, a suggested therapy, a suggested inquiry to aid in establishing a diagnosis, a suggested medical test, a recommended source for further information, and a recommended medical professional. The parameters include, but are not limited to, choices for a type of information sought, such as a diagnosis, a therapy, an inquiry to aid in establishing a diagnosis, a medical test, a recommended source for further information, and a recommended medical professional, and a type of therapeutic or surgery. In certain embodiments, a suggested diagnosis, a suggested therapy, a suggested inquiry to aid in establishing a diagnosis, a suggested medical test, a recommended source for further information, and a recommended medical professional, can be a change in anyone thereof (e.g., a change in a diagnosis or a change in therapy). In certain embodiments, a degree of identity includes gradations, including a binary absence or presence (e.g., no similarity or complete similarity). For example, the degree of identity with the first session parameters can include an indication that the other session is similar to the first session in any one of a number of ways. For example, the query in the other session can be for a patient that has one or more similar, if not identical, complaints as did a patient from the first session. As another example, the query in the other session can include a similar therapy, diagnosis, inquiry, medical test, source for further information, or medical professional as the query in the first session. As yet another example, the query in the other session can include demographic factors such as age, socioeconomic status, geographic location and environmental factors, past medical history, or anything else the query can be about. Weighting factors, as discussed below, can be used to determine the similarity of the session parameters, such as by using a number of parameters matched.

The server 130 can be any device having an appropriate processor, memory, and communications capability for receiving and transmitting the information identified above. The client 110 and medical personnel devices 120 to which the server 130 is connected over the network 150 can be, for example, desktop computers, mobile computers, tablet computers, mobile devices (e.g., a smartphone or PDA), or any other devices having appropriate processor, memory, and communications capabilities. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

In certain embodiments of the disclosed system, a one-to-many credentialing system and statistical appraisal of crowd-sourced data is used in an integrated platform consisting of a central disease information database (“DANA”) and inference engine that is coupled with a system that allows providers to broadcast clinical queries to content experts in near-real time. Social networking may be used to encourage user participation and support user trust in both the differential diagnosis inference engine and the data used to populate the program. Such a hybrid approach provides unique insight regarding how to optimize software and hardware systems to facilitate socially intelligent computing in both the clinical and educational realm.

The disclosed system addresses many concerns, such as diagnosing a disease from amongst several diseases that exhibit disease feature overlap, streamlining interaction with a large clinical database, and increasing trust in users to use software incorporating the disclosed system. Additional concerns that are addressed include providing alternatives to artificial intelligence systems that do not faithfully replicate expert decisions, limited peer-to-peer networking options, and form factors that do not conform with clinical work flow.

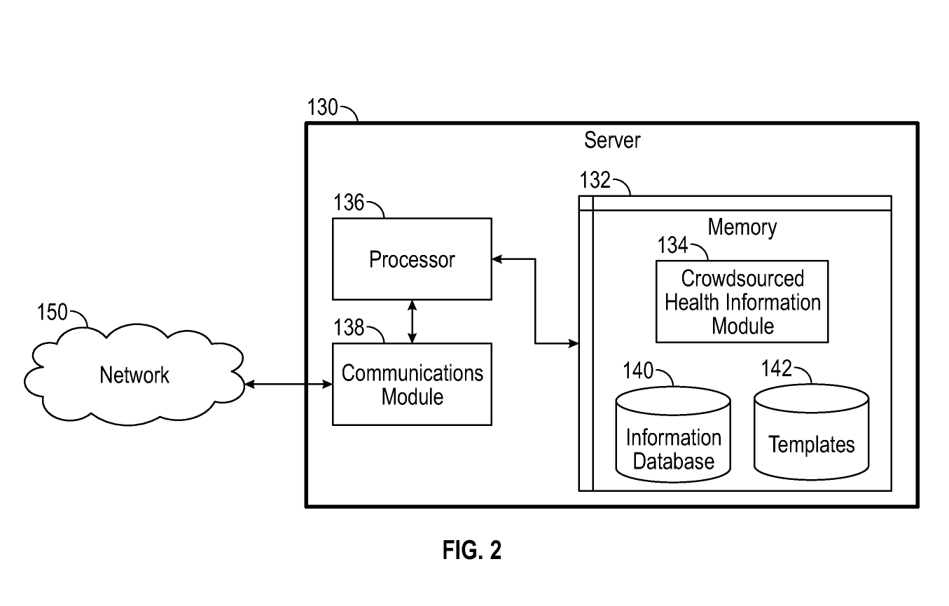

FIG. 2 illustrates an exemplary server 130 according to the architecture 100 of FIG. 1. The server includes a processor 136, communications module 138, and memory 132. The memory 132 includes a crowdsourced health information module 134, information database 140, and templates 142. The processor 136 of the server 130 is configured to execute instructions, such as instructions physically coded into the processor 136, instructions received from software in memory 132, or a combination of both. For example, the processor 136 of the server 130 is configured to execute instructions from the crowdsourced health information module 134 causing the processor 136 to receive, from a user during a first session over the network 150, a query including a request for information regarding at least one of a patient condition, a therapy, and a medical test, and transmit the query over the network 150 to a plurality of medical personnel. In certain embodiments, the medical personnel include personnel identified from out-of-network providers, patients diagnosed by participating clinicians, or using the Internet generally. In certain embodiments, the medical personnel and the user are required to provide authentication to use the disclosed system.

The query further includes first session parameters selected by the user from categories displayed by a processor (e.g., of the user client 110) to the user, the categories including therapies, diseases, organ systems, symptoms, clinical signs, medical tests, medical imaging, and genetic information. In certain embodiments, the categories are unnecessary, and the first session parameters can be selected by the user generally. In certain embodiments, the parameters are organized using electronic data tags, and in certain embodiments, the query is selected by the user based on a template stored in a templates 142 database in the memory 132. The template can, for example, include a pre-defined set of sub-queries for selection or configuration by the user, and can, for example, be tailored to one or many specific therapy types, diseases, organ systems, symptoms, clinical signs, medical tests, medical imaging, diagnoses, therapies, inquiries to aid in establishing a diagnosis, a sources for further information, and/or medical professionals. In certain embodiments, the queries or the sub-queries can be presented in a multiple-choice format for selection by the user for inclusion in the communication sent to medical personnel. The parameters can be generated or otherwise identified based on common lexicon structure, data associated with discrete diseases and physical exam findings, and laboratory tests. Parameters based on discrete terms describing obscure historical acronyms, biomedical concepts, and other jargon can be contained within a simple glossary. Parameters based on test related information can include relevant disease associations and detail regarding the premise of the study. Parameters based on common diseases, for example, neurological diseases covering the core clinical domains (headache, stroke, behavioral neurology, movement disorders, neuroimmunology, infectious diseases, oncology, critical care, epilepsy, neuromuscular, pediatric neurology, psychiatry) can be contributed by the user base. These can include discrete data like age of onset, associated medical conditions, common symptoms, expected physical findings (signs), associated lab abnormalities, high-yield questions to ask on history, associated treatments and impact on mortality. Parameters can be based on data sources such as textbooks and other medical reference materials, case reports from medical literature, and personally contributed data derived from sources including grand rounds cases and other provider experiences with individual patients. Parameters can further be based on clinical case information, which can serve as the basis for the clinical query and include the age, gender, medical history, symptoms, exam findings, and lab data derived from a clinical encounter. In certain embodiments, personal health information (PHI) that can be used to identify individual patients is not used.

The processor 136 further receives responses over the network 150 to the query from medical personnel. The responses can include a suggested diagnosis, a suggested therapy, a suggested inquiry to aid in establishing a diagnosis, a suggested medical test, a recommended source for further information, and/or a recommended medical professional. In certain embodiments, the responses can be stored in an information database 140 in the memory 132. In certain embodiments, the responses can include categories for the first session parameters selected by the medical personnel if the categories were not previously selected by the user. The processor 136 may further be configured to execute instructions to transmit a follow-up query to the at least two of the plurality of medical personnel for additional information based on the received responses. The processor 136 may yet further be configured to execute instructions to transmit information, based on the responses from the medical personnel, to at least a portion of the remaining plurality of medical personnel, who, for example, have asked to receive information related to the responses. In certain embodiments, medical personnel receive incentives for providing the responses, and in certain embodiments, medical personnel may each have a different level of access. For example, the incentives can include promotion to greater status, social incentives or recognition, and/or explicit compensation.

In certain embodiments, the processor 136 is configured to execute instructions to compile statistics associated with a suggested diagnosis, suggested therapy, suggested inquiry to aid in establishing a diagnosis, suggested medical test, recommended source for further information, and/or recommended medical professional based on the responses. In certain embodiments, the processor 136 is configured to store user created information associated with a suggested diagnosis, suggested therapy, suggested inquiry to aid in establishing a diagnosis, suggested medical test, recommended source for further information, and/or recommended medical professional based on the responses. The origin of the data within the disclosed system (e.g., in the information database 140 or the templates 142 database) can be tracked at the time of generation. For example, contributor credentials linked to data can be made visible to a user. Users can log in to the disclosed system to manage data submission and/or run queries depending on designated permissions. For example, cases generated by a user can be saved in a personal case log as discrete events, providing the ability to refine a diagnosis as additional testing data becomes available. As another example, a group of medical students enrolled in a second year medical school course can use their mobile client devices 110 to create a user-network create a rich collection of disease pages on the server 130, and have access to information contributed by colleagues that share data. The students can thus have access to information regarding symptoms, signs, associated laboratory findings, incidence and mortality statistics, high yield clinical questions, and other relevant data. Per institutional standards, patients older than 89 years of age can be generically indicated as such in the disclosed system and information regarding their geographic location can be restricted to country and state.

Based on the responses from the medical personnel, the processor 136 changes an assigned probability of presenting to an indexed user (e.g., on the user client 110), during another session having parameters that share a degree of identity with the first session parameters, such as a suggested diagnosis, a suggested therapy, a suggested inquiry to aid in establishing a diagnosis, a suggested medical test, a recommended source for further information, and/or a recommended medical professional. The instructions to present to the user during another session can include instructions to present, based on the responses, a differential list of suggested diagnoses, suggested therapies, suggested inquiries to aid in establishing the diagnosis, suggested medical tests, recommended sources for further information, and/or recommended medical professionals.

In certain embodiments, the assigned probability is changed based on weighting of variables, and in certain embodiments, the weighting of variables includes providing a weight to the medical personnel, suggested diagnosis, suggested therapy, suggested inquiry to aid in establishing a diagnosis, suggested medical test, recommended source for further information, and/or recommended medical professional. In certain embodiments, the weighting of variables includes assigning a heavier weight to a diagnosis that has a greater potential for morbid consequences than a diagnosis that has a lesser potential for morbid consequences, and in certain embodiments, the weighting of variables includes assigning different weights to responses received from the personnel versus a suggested diagnosis, a suggested therapy, a suggested inquiry to aid in establishing a diagnosis, or a suggested medical test identified in a medical reference. For example, in certain aspects, weighted terms in linear or nonlinear equations can be used, where, based on received responses from medical personnel, weights assigned to those responses are varied. The weights may be expressed as coefficients multiplying the variables in the terms of an equation. The resulting output, which can be the probability of producing a given answer, can be ranked with more heavily weighted responses displaying more prominently in the results presented to the indexed user (e.g., ranking responses form trusted colleagues more heavily than responses from colleagues unfamiliar to the user).

For example, in certain embodiments, the assigned probability of a suggested actual diagnosis is changed based on the received responses as well as a set of symptoms, patient demographics (age, gender, health history, etc.), and previous test results. The assigned probability of a suggested differential diagnosis is changed based on the received responses as well as a diagnosis set and previous test tests (and possibly symptoms and demographics as well), and further a recommendations to perform one or more tests may also be provided.

The calculation of weights may be based on a probabilistic (e.g., Bayesian) model, such as a naïve Bayesian model that is discriminative, diagnostic, or generative (i.e., causal). Users of the system can select any combination of models to calculate weights, such as models based on universally accepted (e.g., textbook) knowledge, models that incorporate information from trusted sources (e.g., colleagues, institutions, members of a class or study group), and models that incorporate information from all users at large.

In certain embodiments, the processor 136 is further configured to execute the instructions to transmit to the user of the user client 110 an indicator of the responses to the query received over the network 150 from medical personnel. In certain embodiments, the indicator of the responses is at least partially based on the changed assigned probability.

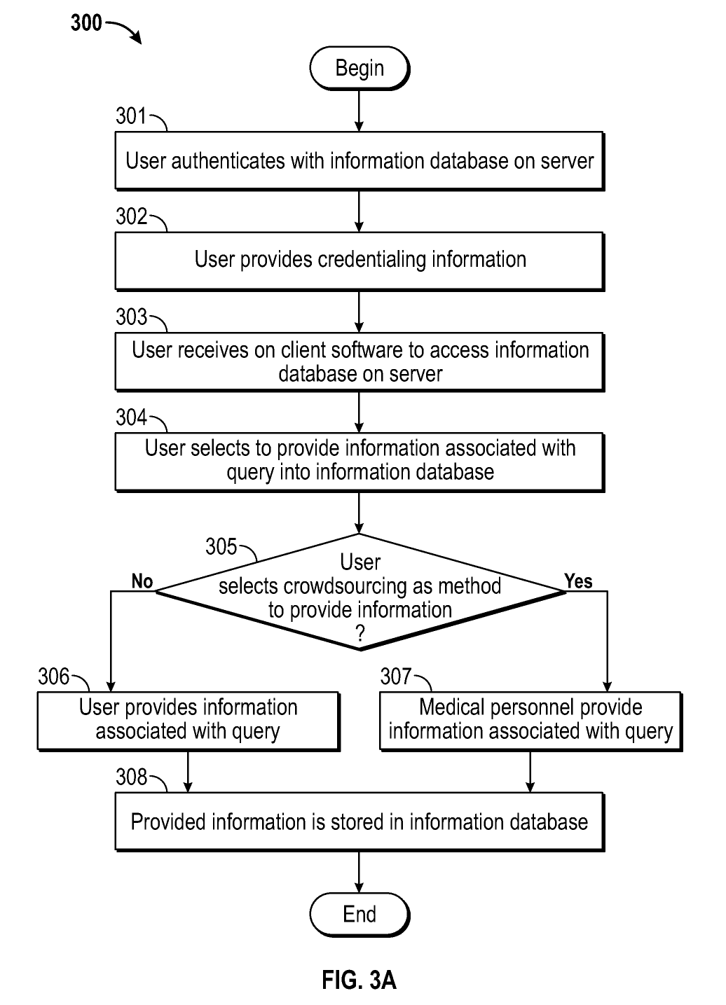

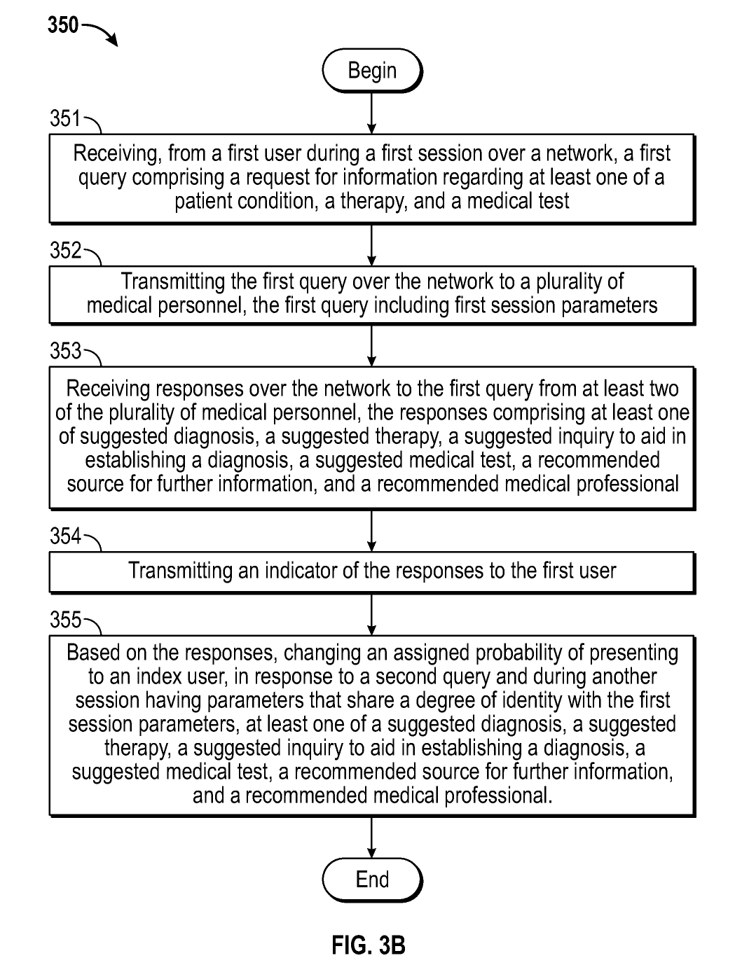

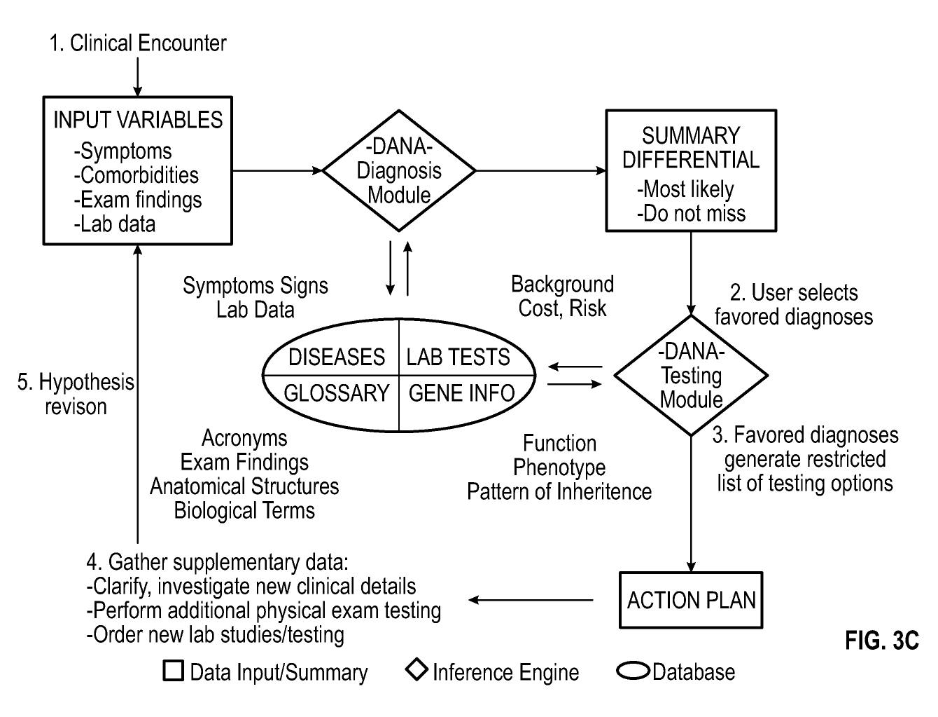

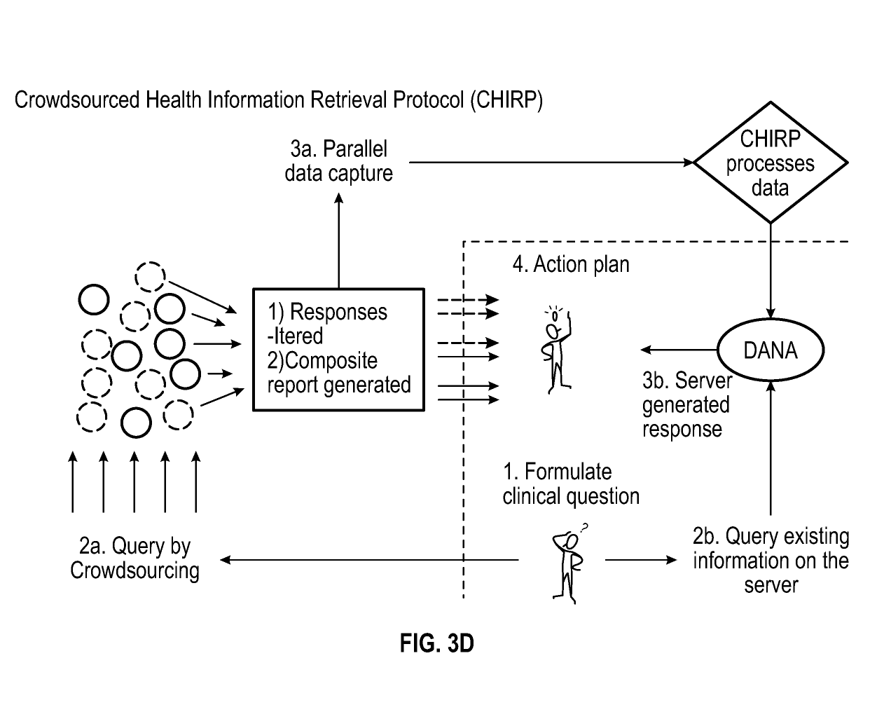

As discussed above, if information related to a query is not readily available in the memory 132 of the server 130, a user can provide the information or call on his/her colleagues listed in the user's “keychain” of content experts to provide the information. FIG. 3A illustrates an exemplary process 300 for providing information associated with a query. The process 300 begins in step 301, in which a user authenticates (e.g., provides a username and password) access to the information database 140 on the server 130. The user then provides credentialing information in step 302. Exemplary credentialing information includes, for example, the user's expertise, level of training, accreditations, and group affiliations. In step 303, the user receives (e.g., downloads) software on the user client 110 for accessing the information database 140 on the server 130, and in step 304, the user selects to provide information associated with a query into the information database 140. The query may not otherwise have any information associated with it. In decision step 305, the user decides whether to provide the information or whether crowdsourcing (e.g., asking a plurality of other users) should be used to provide the information. If the user decides in step 305 not to use crowdsourcing, then the user provides the information in step 306, such as by manually entering information or purchasing information to associate with the query. If the user decides in step 305 to use crowdsourcing, then medical personnel (e.g., the crowd) provide the information in step 307, such as by generating the information or purchasing the information to associate with the query. The user may also add to the information provided by the medical personnel. The provided information is incorporated in step 308, and the process 300 ends.

FIG. 3B is an exemplary process 350 for crowdsourcing medical expert information using the server 130 of FIG. 2. The process 350 begins in step 351, in which the server 130 receives, from a user during a first session over the network 150, a query including a request for information regarding at least one of a patient condition, a therapy, and a medical test. In step 352, the server 130 transmits the query over the network 150 to the medical personnel devices 120, each of the medical personnel devices 120 associated with a medical professional. The query further includes first session parameters selected by the user from categories displayed to the user. The categories include therapies, disease, organ systems, symptoms, clinical signs, medical tests, medical imaging, and/or genetic information. In step 353, the server 130 receives responses over the network to the query from the medical personnel. The responses may include a suggested diagnosis, a suggested therapy, a suggested inquiry to aid in establishing a diagnosis, a suggested medical test, a recommended source for further information, and/or a recommended medical professional. Based on the responses, in step 354 the server 130 transmits an indicator of the responses to the first user, and in step 355 the server 130 changes an assigned probability of presenting to a user, during another session having parameters that share a degree of identity with the first session parameters, a suggested diagnosis, a suggested therapy, a suggested inquiry to aid in establishing a diagnosis, a suggested medical test, a recommended source for further information, and/or a recommended medical professional.

Having set forth in FIG. 3B an exemplary process 350 for crowdsourcing medical expert information using the server 130 of FIG. 2, a series of examples will now be described using the disclosed system.

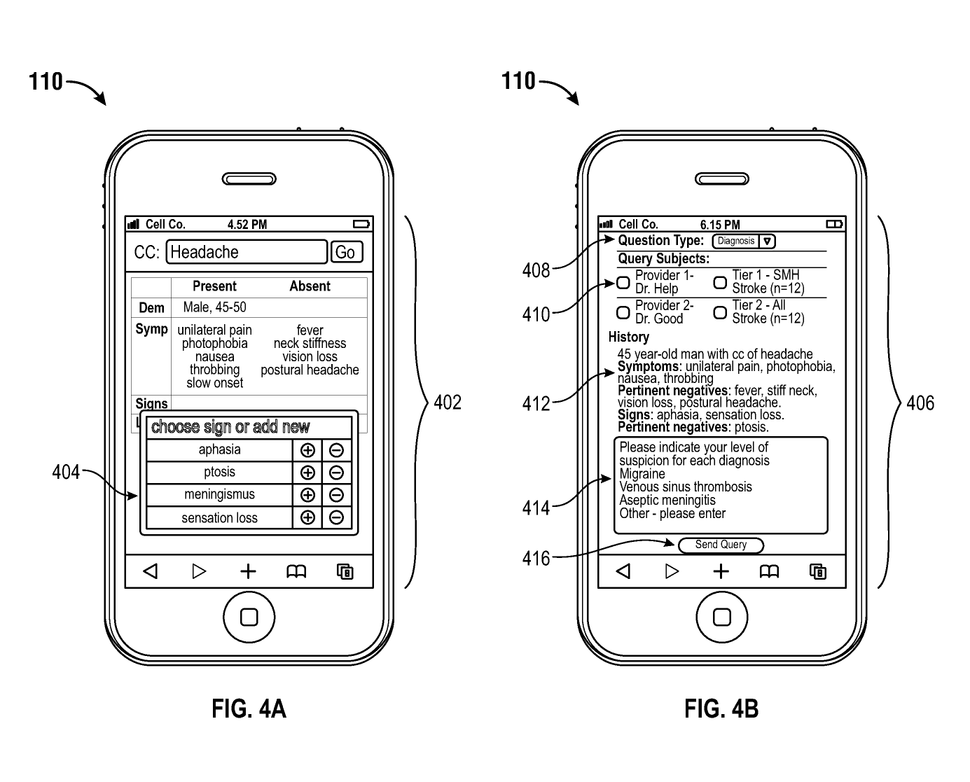

A first example refers to the exemplary process 350 of FIG. 3B and a query for assistance diagnosing a headache. The process 350 begins in step 351, in which the server 130 receives, from a mobile phone user during a first session over the network 150, a query including a request for assistance diagnosing a headache. FIG. 4A illustrates an exemplary screenshot of the user's mobile phone 110 displaying a first query generation screen 402 that includes session parameters. The first query generation screen 402 includes demographic information on the patient, patient symptom information, and patient signs. A pop up window 404 for entering patient signs is provided. FIG. 4B illustrates an exemplary screenshot of the user's mobile phone 110 displaying a second query generation screen 406 that includes additional session parameters. The second query generation screen 406 includes information on the query type 408 (e.g., a diagnosis), an identification of the medical personnel 410 selected to receive the query, a history 412 of the patient, an input field 414 for a level of suspicion regarding the query, and a button 416 to transmit the query.

In step 352, the server 130 transmits the headache diagnosis query over the network 150 to the medical personnel 410 selected in FIG. 4B. In step 353, the server 130 receives responses over the network to the query from the medical personnel, the responses including suggested diagnoses for the headache. Based on the responses, in step 354 the server 130 transmits an indicator of the responses to the first user, and in step 355 the server 130 changes an assigned probability of presenting to an index user (e.g., the same user or a different user), during another session having parameters that share a degree of identity with the first session parameters of the headache query, a suggested diagnosis for the headache.

In another example, a solo practitioner in rural Vermont notes a last minute patient add-on to her afternoon schedule. Review of the patient's chart reveals that the patient continues to experience break-through partial seizures despite therapeutic levels of two anticonvulsants. The patient's appointment with a neurologist in Burlington is five weeks away. The solo practitioner recalls that the FDA recently approved Vimpat (lacosamide) for partial seizures, but the solo practitioner has no experience with its use. Before the solo practitioner begins seeing patients for the afternoon, the solo practitioner uses her mobile client device 110 to select a therapy template and send a query based on the therapy template to the four neurologists registered on the solo practitioner's provider key chain. Within 25 minutes, the solo practitioner receives three responses recommending Keppra (levetiracetam) over Vimpat because of ease of titration, cost, and overall efficacy. The query and the responses are stored on the server 130 so that future recommendations by the server 130 regarding similar therapy related requests can be provided based on the three responses. In the following weeks there is a spike in queries regarding the use of Vimpat. These data are retrieved by the server 130 and a summary of the responses to the queries is broadcast to users that have indicated an interest in the subject.

In yet another example, a neurology consult service has received six consult requests by mid-morning, and by days end, they will have visited five patient care wards, visited two intensive care units, and rushed to the emergency department for two acute stroke cases. Currently, they are evaluating a 42 year old patient with a chief complaint of transient facial weakness. In taking her history, the patient describes experiencing years of intermittent headaches and burning pain in her feet. Additional positive features include several family members with headaches. The physical exam reveals evidence of a mild length-dependent neuropathy, and available lab studies including CT and MRI of the brain are normal. While the consult attending suspects these clues contributed the patient's main reason for admission, the consult is neither certain of the diagnosis nor certain regarding the best course of action. Several team members have reference materials on their mobile devices but none support complex search strategies. The hospital has also just rolled out its new electronic medical record and all terminals are currently in use. Using a mobile-device specific application for the disclosed system, the attending physician uses his mobile device 110 to query the disclosed system with the keywords “stroke,” “neuropathy,” and “headache.” In certain embodiments, the mobile application records interactions with the device (e.g., number of submissions, use statistics) on the server 130, which allow for an analysis, for example, of whether questions requiring answerers to choose from several provided options are more quickly answered than questions requiring answerers to input a natural language response. The disclosed system returns migraine, arterial dissection, diabetes, Tangier's disease, malignancy, CADASIL, and Fabry disease as potential diagnoses. “Do not miss” items that are returned include sub-arachnoid hemorrhage and stroke, which receive low overall ranking scores given the normal imaging. The attending picks a subset of diagnoses for further consideration, and the disclosed system returns a short list of laboratory tests, additional questions for the patient, and recommends additional attention be paid to the cardiovascular exam. In this case, the directed examination returns negative findings, but inquiry regarding the family history identifies an aunt with early onset dementia. With these data, the disclosed system ranks GADASIL highly and recommends a skin biopsy to make the diagnosis. The attending physician also uses the disclosed system to contact several colleagues asking their opinion on the list presented by the disclosed system. The disclosed system suggests three stroke neurologists from the attending physician's personalized consultant key-chain and lists another four stroke neurologists connected through a mutual colleague. The query in this case uses a template populated by elements of the patient's history, and lists the potential diagnoses with additional free text fields. The colleagues, recipients of the query, receive a notice on their mobile phones of the query and provide their input, including adding new diagnoses to the list. Within twenty minutes the server 130 receives answers from three of the seven recipients invited to participate. The server 130 processes the responses and the treating physician receives a summary with updates as the data from the responses are captured. In this case, two of the attending physician's three colleagues outside of the attending physician's personalized consultant key-chain suggest adding vasculitis and antiphospholipid syndrome to the set of diagnoses. Recognizing that neither diagnosis currently exist in the database, the disclosed system sends stub requests for information from the contributing user base to improve upon future performance of the system. One colleague feels that given its prevalence, diabetes is most likely to blame; however, the attending physician downgrades this vote having just seen that the patient's HbAlC value was normal. With these new data, the attending physician recommends skin biopsy, which confirms the diagnosis. The disclosed system updates probabilities of presenting future recommendations in similar circumstances based on the data received.

Returning to FIGS. 3C and 3D, FIG. 3C illustrates an exemplary workflow for a central disease information database (e.g., information database 140) in accordance with certain aspects of the disclosure, and FIG. 3D illustrates an exemplary workflow for a crowdsourced health information retrieval protocol (e.g., crowdsourced health information module 134) in accordance with certain aspects of the disclosure. Specifically, FIG. 3C illustrates an example workflow of how a central disease information database will be used and updated, showing the tightly coupled inputs of the user, expert medical system, and crowd, resulting in an action plan. FIG. 3D illustrates the crowdsourcing of answers to clinical questions with the central disease information database. Physicians are assisted in formulating their clinical questions by the mobile application and the central disease information database inference engine. If the physician chooses, she may also query their social network for answers to clinical questions, which appear as easy-to-answer notifications on the appropriate colleagues' mobile devices. Answers are aggregated and returned to the asker's mobile device, and used to improve the central disease information database inference engine.

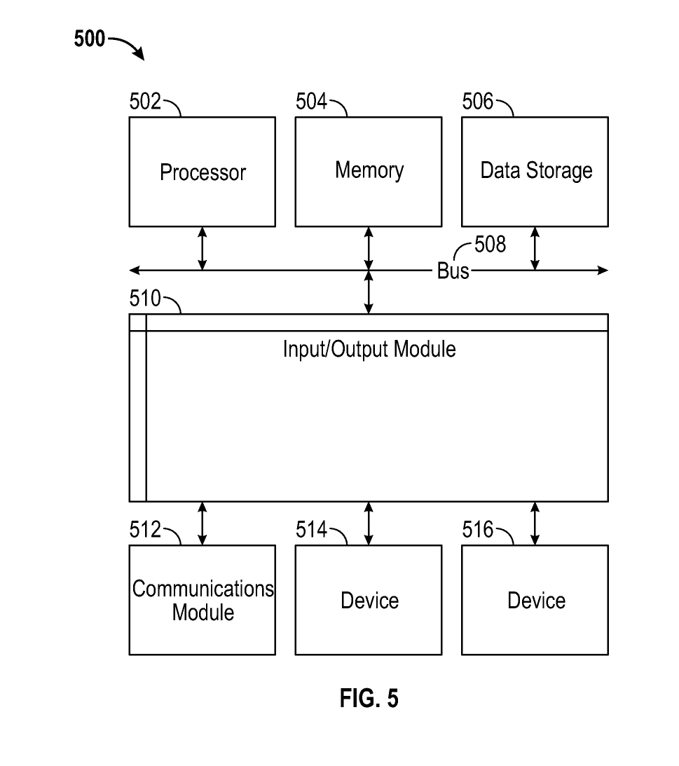

FIG. 5 is a block diagram illustrating an example of a computer system 500 with which the user client 110, server 130, and medical personnel devices 120 of FIG. 1 can be implemented. In certain embodiments, the computer system 500 may be implemented using software, hardware, or a combination of both, either in a dedicated server, or integrated into another entity, or distributed across multiple entities.

Computer system 500 (e.g., user client 110, server 130, and/or medical personnel devices 120) includes a bus 508 or other communication mechanism for communicating information, and a processor 502 (e.g., processor 136) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. Computer system 500 also includes a memory 504 (e.g., memory 132), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The instructions may be implemented according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502. Computer system 500 further includes a data storage device 506 such as a magnetic disk or optical disk, coupled to bus 508 for storing information and instructions. Computer system 500 may be coupled via communications module 560 (e.g., communications module 138) to various devices (not illustrated). The communications module 510 can be any input/output module. In certain embodiments not illustrated, the communications module 510 is configured to connect to a plurality of devices, such as an input device and/or a display device.

According to one aspect of the present disclosure, the user client 110, server 130, and/or medical personnel devices 120 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative embodiments, hard-wired circuitry may be used in place of or in combination with software instructions to implement various embodiments of the present disclosure. Thus, embodiments of the present disclosure are not limited to any specific combination of hardware circuitry and software.

The term “machine-readable storage medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read.

As used herein, the phrase “at least one of” preceding a series of items, with the terms “and” or “or” to separate any of the items, modifies the list as a whole, rather than each member of the list (i.e., each item). The phrase “at least one of does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A method of crowdsourcing medical expert information, comprising:
receiving, from a first user during a first session over a network, a first query comprising a request for information regarding at least one of a patient condition, a therapy, or a medical test;
transmitting the first query over the network to a plurality of medical personnel;
wherein the first query further comprises first session parameters selected by the first user from categories displayed by a processor to the first user, the categories comprising at least two of: therapies, diseases, organ systems, symptoms, clinical signs, medical tests, medical imaging, and genetic information;
receiving responses over the network to the first query from at least two of the medical personnel, the responses comprising at least one of suggested diagnosis, a suggested therapy, a suggested inquiry to aid in establishing a diagnosis, a suggested medical test, a recommended source for further information, or a recommended medical professional;
transmitting to the first user an indicator of the responses; and
based on the responses, changing an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

2. The method of claim 1, further comprising transmitting to the index user an indicator of the responses.

3. The method of claim 2, wherein the indicator of the responses is at least partially based on the changed assigned probability.

4. The method of claim 1, wherein the first user is the index user.

5. The method of claim 1, wherein at least some of the first session parameters are organized using electronic data tags.

6. The method of claim 1, wherein the assigned probability is changed based on a weighting of variables, wherein each of at least some of the variables represents a degree of similarity or of difference between the first and second queries.

7. The method of claim 6, wherein the weighting of variables comprises providing a weight to at least one of the medical personnel, suggested diagnosis, suggested therapy, suggested inquiry to aid in establishing a diagnosis, suggested medical test, recommended source for further information, or recommended medical professional.

8. The method of claim 6, wherein the weighting of variables comprises assigning a heavier weight to a diagnosis that has a greater potential for morbid consequences than a diagnosis that has a lesser potential for morbid consequences.

9. The method of claim 6, wherein the weighting of variables comprises assigning a different weight to a response received from at least one of the plurality of personnel than from at least another of the plurality of personnel.

10. The method of claim 9, wherein the different weight is based at least in part on a reputation of the least one of the personnel, the reputation being based on at least a prior answer provided by the least one of the personnel to a prior query received from a user.

11. The method of claim 1, wherein the at least two of the plurality of medical personnel receive incentives for providing the responses.

12. The method of claim 1, further comprising providing to at least one of the plurality of medical personnel a different level of access to information regarding the first query than to another of the medical personnel.

13. The method of claim 1, further comprising:
compiling statistics associated with the at least one of suggested diagnosis, suggested therapy, suggested inquiry to aid in establishing a diagnosis, suggested medical test, recommended source for further information, or recommended medical professional based on the responses; and
displaying the statistics to at least one of the first and index users.

14. The method of claim 1, wherein the query is selected by the first user from a group of queries displayed to the first user.

15. The method of claim 1, further comprising transmitting information, based on the responses, to at least some of the medical personnel.

16. The method of claim 1, further comprising transmitting a follow-up query to the at least two of the plurality of medical personnel for additional information based on the received responses.

17. The method of claim 1, wherein the presenting to the index user during another session comprises presenting, based on the responses, at least one of a differential list of suggested diagnoses, a suggested therapy, a suggested inquiry to aid in establishing a diagnosis, a suggested medical test, a recommended source for further information, or a recommended medical professional.

18. A system of crowdsourcing medical expert information, comprising:
a memory storing instructions; and
a processor configured to execute the instructions to:
receive, from a first user during a first session over a network, a query comprising a request for information regarding at least one of a patient condition, a therapy, or a medical test;
transmit the query over the network to a plurality of medical personnel;
wherein the query further comprises first session parameters selected by the first user from categories displayed by a processor to the first user, the categories comprising at least two of: therapies, diseases, organ systems, symptoms, clinical signs, medical tests, medical imaging, or genetic information;
receive responses over the network to the first query from at least two of the plurality of medical personnel, the responses comprising at least one of suggested diagnosis, a suggested therapy, a suggested inquiry to aid in establishing a diagnosis, a suggested medical test, a recommended source for further information, or a recommended medical professional;
transmit to the first user an indicator of the responses; and
based on the responses, change an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

19. The system of claim 18, wherein the processor is further configured to execute the instructions to transmit to the index user an indicator of the responses.

20. The system of claim 19, wherein the indicator of the responses is at least partially based on the changed assigned probability.

21. The system of claim 18, wherein the first user is the index user.

22. The system of claim 18, wherein at least some of the first session parameters are organized using electronic data tags.

23. The system of claim 18, wherein the assigned probability is changed based on a weighting of variables, wherein each of at least some of the variables represents a degree of similarity or of difference between the first and second queries.

24. The system of claim 23, wherein the weighting of variables comprises providing a weight to at least one of the medical personnel, suggested diagnosis, suggested therapy, suggested inquiry to aid in establishing a diagnosis, suggested medical test, recommended source for further information, or recommended medical professional.

25. The system of claim 23, wherein the weighting of variables comprises assigning a heavier weight to a diagnosis that has a greater potential for morbid consequences than a diagnosis that has a lesser potential for morbid consequences.

26. The system of claim 23, wherein the weighting of variables comprises assigning a different weight to a response received from at least one of the plurality of personnel than from at least another of the plurality of personnel.

27. The system of claim 26, wherein the different weight is based at least in part on a reputation of the least one of the personnel, the reputation being based on at least a prior answer provided by the least one of the personnel to a prior query received from a user.

28. The system of claim 18, wherein the at least two of the plurality of medical personnel receive incentives for providing the responses.

29. The system of claim 18, wherein the processor is configured to execute the instructions to provide to at least one of the plurality of medical personnel a different level of access to information regarding the query than to another of the plurality of medical personnel.

30. The system of claim 18, wherein the processor is further configured to execute the instructions to compile statistics associated with the at least one of suggested diagnosis, suggested therapy, suggested inquiry to aid in establishing a diagnosis, suggested medical test, recommended source for further information, or recommended medical professional based on the responses, and display the statistics to at least one of the first and index users.

31. The system of claim 18, wherein the query is selected by the first user from a group of queries displayed to the first user.

32. The system of claim 18, wherein the processor is further configured to execute the instructions to transmit information, based on the responses, to at least some of the medical personnel.

33. The system of claim 18, wherein the processor is further configured to execute the instructions to transmit a follow-up query to the at least two of the plurality of medical personnel for additional information based on the received responses.

34. The system of claim 18, wherein the instructions to present to the index user during another session comprises instructions to present, based on the responses, at least one of a differential list of suggested diagnoses, a suggested therapy, a suggested inquiry to aid in establishing the diagnosis, a suggested medical test, a recommended source for further information, or a recommended medical professional.

35. The system of claim 18, wherein the plurality of medical personnel is authorized to provide responses based on user credentials.

36. The system of claim 18, wherein the first query and the responses are received from at least one of a desktop computer, a mobile device, or an online user interface.

37. The system of claim 18, wherein the first query is received at a server from a mobile device and the responses are received at the server.

38. A machine-readable storage medium comprising machine-readable instructions for causing a processor to execute a method of crowdsourcing medical expert information, comprising:
receiving, from a first user during a first session over a network, a first query comprising a request for information regarding at least one of a patient condition, a therapy, or a medical test;
transmitting the first query over the network to a plurality of medical personnel;
receiving responses over the network to the first query from at least two of the plurality of medical personnel, the responses comprising at least one of suggested diagnosis, a suggested therapy, a suggested inquiry to aid in establishing a diagnosis, a suggested medical test, a recommended source for further information, or a recommended medical professional;
transmitting to the first user an indicator of the responses; and
based on the responses, changing an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

39. A method of crowdsourcing medical expert information, comprising:
receiving, from a first user during a first session over a network, a first query comprising a request for information regarding at least one of a patient condition, a therapy, or a medical test;
transmitting the first query over the network to a plurality of medical personnel;
wherein the first query further comprises first session parameters selected by at least one of the first user and at least one of the plurality of medical personnel from user categories displayed by a processor, the categories comprising at least two of: therapies, diseases, organ systems, symptoms, clinical signs, medical tests, medical imaging, or genetic information;
receiving responses over the network to the first query from at least two of the plurality of medical personnel, the responses comprising at least one of suggested diagnosis, a suggested therapy, a suggested inquiry to aid in establishing a diagnosis, a suggested medical test, a recommended source for further information, or a recommended medical professional;
transmitting to the first user an indicator of the responses; and
based on the responses, changing an assigned probability of presenting to an index user, in response to a second query and during another session having parameters that share a degree of identity with the first session parameters, at least one of a suggested diagnosis, a suggested therapy, a suggested inquiry to aid in establishing a diagnosis, a suggested medical test, a recommended source for further information, or a recommended medical professional.

40. The method of claim 39, wherein the first session parameters are selected from the user categories by the at least one of the plurality of medical personnel.
